(19) United States
(12) Patent Application Publication
(10) Pub. No.: US 2023/0166447 A1
(43) Pub. Date: Jun. 1, 2023

(54) REFLECTIVE AGENTS IN 3D PRINTERS

(71) Applicant: HEWLETT-PACKARD DEVELOPMENT COMPANY, L.P., Spring, TX (US)

(72) Inventors: Ferran Esquius Berengueras, Sant Cugat del Valles (ES); Ismael Chanclon Fernandez, Sant Cugat del Valles (ES); Esteve Comas Cespedes, Sant Cugat del Valles (ES)

(21) Appl. No.: 17/906,049

(22) PCT Filed: Mar. 31, 2020
(86) PCT No.: PCT/US2020/026014

§ 371 Date: Sep. 9, 2022

(51) Int. Cl. B29C 64/165; B29C 64/277; B29C 64/393; B33Y 10/00; B33Y 30/00; B33Y 50/02; B33Y 70/00

(52) U.S. Cl. CPC B29C 64/165; B29C 64/277; B29C 64/393; B33Y 10/00; B33Y 30/00; B33Y 50/02; B33Y 70/00

(57) ABSTRACT

A 3D printer is disclosed herein. The 3D printer comprises an energy source comprising solid-state emitters to selectively emit energy to a build material layer in a narrow-band of wavelengths; an agent delivery device to selectively deposit a fusing agent, a detailing agent and a reflective agent on the build material layer in respective independent patterns; and a controller. The reflective agent is to reflect substantially all of the energy at the wavelengths within the narrow-band of wavelengths. The controller is to control the agent delivery device to selectively deposit the fusing agent to a build material layer in a first pattern corresponding to a 3D object to be generated. The controller is further to control the agent delivery device to selectively deposit the detailing agent and the reflective gent to the build material layer in a second pattern and third pattern respectively. The controller is also to control the energy source to apply energy to the first pattern and second pattern in the narrow-band of wavelengths.

### BACKGROUND

Some additive manufacturing or three-dimensional printing systems generate 3D objects by selectively solidifying portions of a successively formed layers of build material in a layer-by-layer basis.

### BRIEF DESCRIPTION OF THE DRAWINGS

The present application may be more fully appreciated in connection with the following detailed description of non-limiting examples taken in conjunction with the accompanying drawings, in which like reference characters refer to like parts throughout and in which:

FIG. 1 is a schematic diagram showing an example of a 3D printer to deposit a reflective agent.

FIG. 2 is a flowchart of an example method of selectively solidifying portions of a layer of build material in a 3D printer.

FIG. 3 is another schematic diagram showing an example of a 3D printer to deposit a reflective agent.

FIG. 4 is a schematic graph showing an example of the reflectance of different colors based on emitted wavelengths.

FIG. 5 is another schematic diagram showing an example of a 3D printer with a reflecting element.

FIG. 6 is a block-diagram of a processor-based system example for selectively solidifying portions of a layer of build material in a 3D printer.

### DETAILED DESCRIPTION

The following description is directed to various examples of additive manufacturing, or three-dimensional printing, apparatus and processes to generate 3D objects. Throughout the present disclosure, the terms “a” and “an” are intended to denote at least one of a particular element. In addition, as used herein, the term “includes” means includes but not limited to, the term “including” means including but not limited to. The term “based on” means based at least in part on.

For simplicity, it is to be understood that in the present disclosure, elements with the same reference numerals in different figures may be structurally the same and may perform the same functionality.

3D printers generate 3D objects based on data in a 3D model of an object to be generated, for example, a CAD computer program product. 3D printers may generate 3D objects by selectively processing layers of build material. For example, a 3D printer may selectively solidify portions of a layer of build material, e.g. a powder, corresponding to a slice of 3D object to be generated, thereby leaving the portions of the layer un-solidified in the areas where no 3D object is to be generated. The combination of the generated 3D objects and the un-solidified build material may also be referred to as build bed. The volume in which the build bed is generated may be referred to as a build chamber.

Suitable powder-based build materials for use in additive manufacturing include, where appropriate, at least one of polymers, metal powder or ceramic powder. In some examples, non-powdered build materials may be used such as gels, pastes, and slurries.

Some 3D printers selectively solidify portions of a build material layer corresponding to the geometry of the object to be generated through the ejection of a printing fluid on to the build material layer. To execute the selective solidification, some 3D printers heat a build material layer with radiant heat from, e.g. halogen lamps or tungsten lamps. This may be referred to pre-heating and is to heat of the build material layer to a temperature slightly below the melting point of the build material. Then, in some examples, the printing fluid may be an energy absorbing printing fluid, such as a fusing agent. The fusing agent is to absorb further radiant heat to cause the portions of build material on which it has been deposited to further heat up and thereby to melt, coalesce, sinter, or fuse the build material which then may solidify upon cooling. In some examples, the composition of the fusing agent comprises carbon black in a liquid carrier, such as water.

However, the fusing agent may absorb an amount of energy such that the excess of the absorbed energy propagates to the neighboring portions of the pre-heated build material. The neighboring portions are not intended to be solidified since the neighboring portions are not part of the 3D object to be generated. This heat propagation phenomenon may be referred to as thermal bleed and may cause the neighboring portions of build material to solidify. Therefore, thermal bleed reduces the part accuracy of the generated 3D printed object.

In order to address thermal bleed, some 3D printing systems selective deposit an additional printing fluid, i.e. a detailing agent, to the pre-heated portions surrounding the portions to which fusing agent is delivered. The detailing agent is a printing fluid that is intended to act as a thermal barrier by cooling down the neighboring pre-heated portions to block the thermal bleed propagation, and thereby avoid heating the neighboring portions.

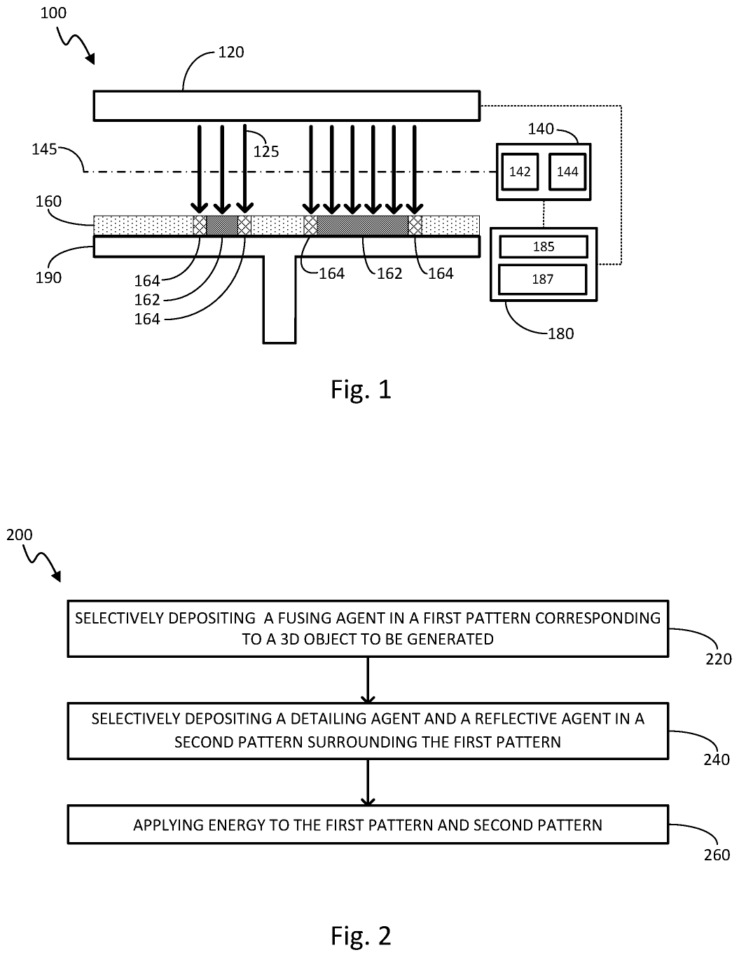

Referring now to the drawings, FIG. 1 is a schematic diagram showing an example of a 3D printer 100.

The 3D printer 100 elements are to interact with a platform 190 in which the build bed is generated. In some examples, the platform 190 is part of the 3D printer 100. In other examples, the platform 190 is part of a removable build unit (not shown) that is to engage and disengage from the 3D printer 100. The platform 190 is a moveable platform within the build chamber. In some examples, the platform 190 is to move vertically within the build chamber, e.g., downwardly for a distance corresponding to the thickness of the successive build material layer to be generated. Some examples of build material layer thicknesses are 80 microns, 60 microns, 50 microns, 30 microns and 20 microns.

The 3D printer 100 may further comprise a recoater (not shown) to generate a layer of build material 160 on the build platform 190 or on the uppermost generated build material layer. The recoater may comprise a recoating roller, a doctor blade, or an overhead build material dispensing hopper, for instance.

The 3D printer 100 includes an energy source 120 comprising an array of solid-state emitters. In an example, the array of solid-state emitters is an array of Light-Emitting Diodes (LED). In another example, the array of solid-state emitters may be an array of Laser Diodes (LD) such as Edge Laser Diodes (ELD). In another example, the array of solid-state emitters may be an array of Vertical-Cavity Surface-Emitting Lasers (VCSEL). In yet another example, the array of solid-state emitters may be a combination of at least two of LEDs, LDs and VCSELS.

LEDs, LDs and VCSELs are formed by semiconductor diodes. The choice of the semiconductor material determines the wavelength of the emitted light beam, which may range from the infra-red to the UV spectrum. In the examples herein, the type of solid-state emitters of the solid-state emitters array is selected to emit energy 125 in a narrow-band of wavelengths to be absorbed by a fusing agent.

Solid-state emitters have a narrow energy emission cone which enables a high-resolution energy emission selectivity. Some examples of narrow emission cones of solid-state emitters are 30°, 20°, 15°, 10°, 5°, 3° and 2°. The high-resolution energy emission selectivity enables the solid-state emitters array to selectively apply energy 125 to the build material layer 160, for example, to the parts of the build material layer 160 where fusing agent have been deposited thereon. Therefore, the high-resolution energy emission selectivity enables a 3D printer 100 to generate 3D printed parts without the pre-heating operation, or pre-heating the build material layer to a lower temperature. However, the energy emission may also emit energy 125 to the immediately neighboring portions which are not intended to be solidified, which may then solidify upon cooling and thereby reduce the part accuracy of the generated 3D object.

In the present disclosure, a narrow-band of wavelengths may be understood as a band of wavelengths from the electromagnetic spectrum which is no wider than 150 nm. In some examples, the narrow-band of wavelengths may include monochromatic light, which comprises a single wavelength. Other examples of narrow-band of wavelengths include a short band of wavelength ranges such as 5 nm, 10 nm, 25 nm, 40 nm, 50 nm, 75 nm, 100 nm, 120 nm or 150 nm. The band of wavelengths width of commercial blue LEDs and UV LEDs ranges from 50 to 70 nm. The band of wavelengths width of commercial ELDs are in the order of 120 nm. These are narrow-band wavelengths compared to the broad band of wavelengths emitted by halogen infrared lamps that may range from 400 to 1200 nm.

In an example, the energy source 120 is implemented as a static overhead top lamp array located above the build material layer 160. The static top lamp array is designed such that at least one energy source from the energy source array 120 is to emit energy to each portion of the build material layer 160.

In another example, the energy source 120 is in a scanning carriage (not shown) located above the build material layer 160 to move along the width and/or the length of the build material layer 160. The scanning carriage may be the same carriage or a different carriage than the agent delivery device 140 described below. In an example, the energy source 120 is to span the full width of the build material layer 160 and is to scan along the length of the build material layer 160. In another example, the energy source 120 is to span the full length of the build material layer 160 and is to scan along the full width of the build material layer 160. In yet another example, the energy source 120 does not span either the full width or the full length of the build material layer 160 and is thereby to scan over the width and the length of the build material layer 160.

The 3D printer 100 further comprises the agent delivery device 140. The agent delivery device 140 is a carriage to scan over the width and/or the length of the build material layer 160 the same or in a similar manner as the examples described above with reference to the scanning carriage comprising the energy source 120.

The agent delivery device 140 is to selectively deposit a fusing agent 142 and a detailing agent 144 on the build material layer 160 in respective independent patterns by means of, for example, a printhead or a plurality of printheads. The printhead may be a thermal inkjet printhead or a piezoelectrical printhead, for instance. For clarity, the pattern corresponding to the deposition of fusing agent 142 is referred to hereinafter as the first pattern 162, and the pattern corresponding to the deposition of the detailing agent 144 is referred to hereinafter as the second pattern 164. The selective deposition of the fusing agent 142 and detailing agent 144 and the first and second patterns 162-164 are described below with reference to FIG. 2.

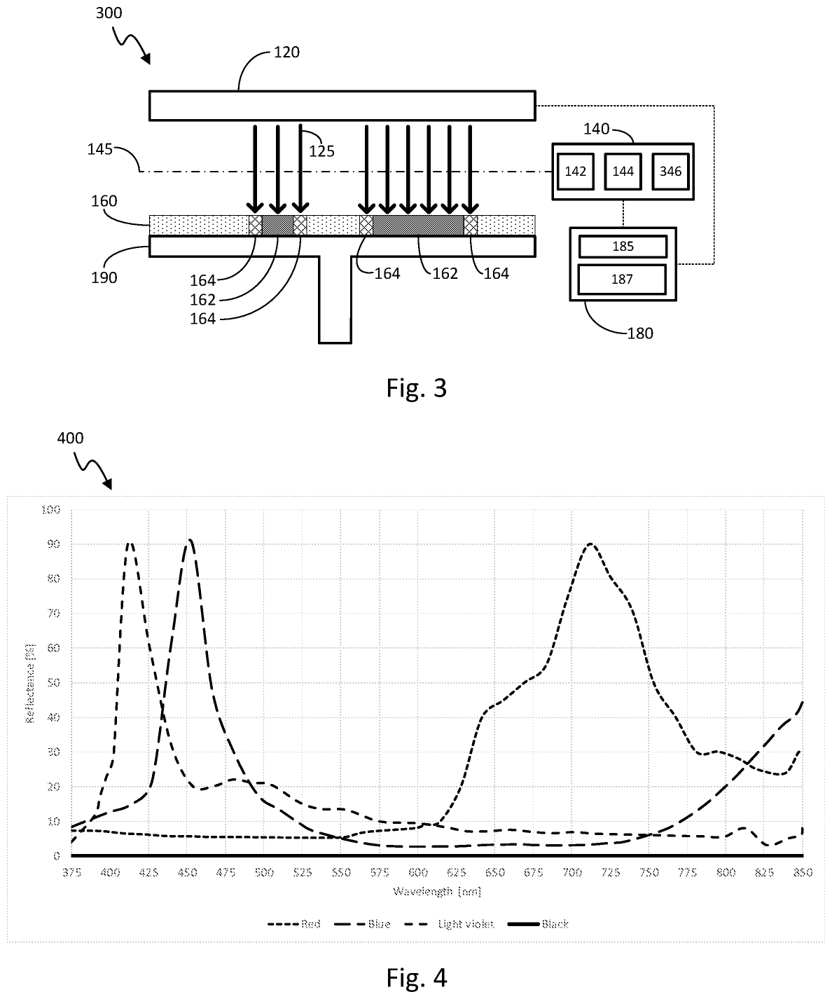

In addition to the fusing agent 142 and the detailing agent 144, the agent delivery device 140 is to selectively deposit a reflective agent in a third pattern, which may be the same as the second pattern 164. In some examples, the reflective agent may be a component of the detailing agent 144 as a single printing agent and the agent delivery device 140 is controlled to jointly deposit the detailing agent 144 and the reflective agent on the build material layer 160 in the second pattern 164. In other examples, the reflective agent may be deposited independently from the detailing agent 144 (see, e.g., FIG. 3) in a different third pattern. A more detailed description with regards to the pattern in which the reflective agent is deposited thereto may be found below with reference to FIG. 2.

The reflective agent is selected to reflect substantially all of the energy 125 at the wavelengths within the narrow-band of wavelengths in the portions of the build material layer 160 where the reflective agent is deposited thereto. The reflectance may be measured by a reflectometer, for example a spectrophotometer.

In an example, the reflective agent is also deposited at the second pattern 164 including the portions of the build material layer 160 surrounding the portions where fusing agent 142 is deposited thereto (i.e., first pattern 162). The energy source 120 may emit energy 125 to the build material layer 160 portions corresponding to the first pattern 162 and the second pattern 164 at a narrow-band of wavelengths which are to be absorbed by the fusing agent of the first portion 162, and reflected by the reflective agent from the second portion 164. Therefore, the portions of build material where fusing agent 142 was deposited thereto are to heat, melt, coalesce, or sinter and solidify upon cooling, and the portions of build material where the reflective agent was deposited are not to heat (or slightly heat) without solidifying upon cooling. This thermal gradient between the fusing agent 142 portions and the reflective agent portions acts as a thermal wall for the thermal bleed phenomenon which leads to the generation of 3D printed objects with sharper dimensional accuracy and improved mechanical properties.

The 3D printer 100 further comprises a controller 180. The controller 180 comprises a processor 185 and a memory 187 with specific control instructions to be executed by the processor 185. The controller 180 is coupled to the energy source 120 and the agent delivery device 140. The controller 180 may control the operations of the elements that it is coupled with. The functionality of the controller 180 is described further below with reference to FIG. 2.

In the examples herein, the controller 180 may be any combination of hardware and programming that may be implemented in a number of different ways. For example, the programming of modules may be processor-executable instructions stored in at least one non-transitory machine-readable storage medium and the hardware for modules may include at least one processor to execute those instructions. In some examples described herein, multiple modules may be collectively implemented by a combination of hardware and programming. In other examples, the functionalities of the controller 180 may be, at least partially, implemented in the form of an electronic circuitry. The controller 180 may be a distributed controller, a plurality of controllers, and the like.

FIG. 2 is a flowchart of an example method 200 of selectively solidifying portions of a layer of build material in a 3D printer, for example the 3D printer 100 of FIG. 1. The method 200 may involve previously disclosed elements from FIG. 1 referred to with the same reference numerals. In some examples, method 100 may be executed by the controller 180.

The method 200 may start when an un-solidified layer of build material 160 is generated on the platform 190 or on the uppermost partially solidified build material layer of a build bed.

At block 220, the controller 180 controls the agent delivery device 140 to selectively deposit an amount of fusing agent 142 to the build material layer 160 in a first pattern 162 corresponding to the 3D object to be generated. In some examples, the controller may slice a CAD computer program product corresponding to the 3D object to be generated comprising the areas from the build material layer 160 to be solidified (i.e. first pattern 162). In other examples, the controller may receive a single slice or a plurality of slices comprising the areas from the build material layer 160 to be solidified (i.e. first pattern 162).

At block 240, the controller 180 controls the agent delivery device 140 to selectively deposit an amount of detailing agent 144 and an amount of reflective agent to the build material layer 160 in a second pattern 164 and third pattern respectively. In some examples the second pattern 164 is a pattern surrounding the first pattern 162. Additionally, the third pattern includes the second pattern 164. In an example, the controller 180 selectively delivers a single agent including both the detailing agent 144 and the reflective agent 144 to the build material layer 160 in the second pattern 164. In another example, the controller 180 selectively delivers the detailing agent 144 and the reflective agent 144 in respective independent patterns, both patterns comprising the second pattern 164 (see, e.g., FIG. 3). A more detailed description relating to examples of the reflective agent 144 may be found with regards to FIG. 4.

In some examples, due to the geometry of the 3D printed part and/or the intensity in which the energy source 120 emits energy 125, the portions of the build material layer 160 corresponding to the first pattern 162 may heat above a temperature threshold indicative of an excessive temperature that may lead to part quality defects (e.g., dimensional accuracy and mechanical defects). In these examples, the controller 180 may control the agent delivery device 140 to deliver an amount of detailing agent 144 to the first portion 162 for temperature regulation purposes but may not deliver reflective agent thereto. The detailing agent 144 may cool down the first portion 162 but may not modify the absorptance/reflectance of the first portion 162. Therefore, in some examples, the detailing agent 144 may be applied to some areas of the first portion 162 in addition to the second portion 164.

At block 260, the controller 180 controls the energy source 120 to apply energy 125 to the first pattern 162 and the second pattern 164 in the narrow-band of wavelengths. The energy source 120 is to apply energy 125 comprising a narrow-band of wavelengths that are to be mostly absorbed by the fusing agent 142 at the first pattern 162 and mostly reflected by the reflective agent at the second pattern 164. This thermal gradient between the first portion 162 and the second portion 164 may act as a thermal wall for the thermal bleed phenomenon which may lead to sharper dimensional accuracy and stronger mechanical properties of the generated 3D printed objects. A more detailed description relating to examples of the narrow-band of wavelengths may be found with regards to FIG. 4.

FIG. 3 is another schematic diagram showing an example of a 3D printer 300 to deposit a reflective agent 346. The 3D printer 300 may involve previously disclosed elements from FIG. 1 referred to with the same reference numerals. The 3D printer 300 comprises the energy source 120 to emit energy 125, the agent delivery device 140 with fusing agent 142 and detailing agent 144, and the controller 180. Additionally, the 3D printer 300 may comprise the platform 190 where the build material layer 160 is to be generated thereon. The controller 180 is to control the agent delivery device 140 to selectively deposit fusing agent 142 and detailing agent 144 on the build material layer 160 in the first pattern 162 and second pattern 164 respectively.

The agent delivery device 140 of 3D printer 300 further comprises a reflective agent 346 to be delivered to the build material layer 160. Therefore, in the example, the detailing agent 144 and the reflective agent 346 are different agents. The controller 180 may control the agent delivery device 140 to separately deposit the detailing agent 144 and the reflective agent 346 on the build material layer 160 in respective independent patterns. In some examples, both patterns may include the second pattern 164.

In an example, the controller 180 controls the agent delivery device 140 to deposit fusing agent 142 in the first pattern 162 and both the detailing agent 144 and the reflective agent 346 in the second pattern 164 to improve the part accuracy of the generated 3D object. In another example, the controller 180 controls the agent delivery device 140 to deposit fusing agent 142 in the first pattern 162; the reflective agent 346 in the second pattern 164; and the detailing agent 144 to the second pattern 164 and at least part of the first pattern 162 to improve the part accuracy of the generated 3D object and for thermal control purposes.

FIG. 4 is a schematic graph 400 showing an example of the reflectance of different colors based on emitted wavelengths.

The energy source 120 is to emit energy in a narrow-band of wavelengths to be absorbed by the fusing agent 142 and to be mostly reflected by the reflective agent 346. Therefore, the narrow-band of wavelengths and the composition of the reflective agent 346 are selected such that these criteria are fulfilled.

As mentioned above, an example of fusing agent composition includes carbon black in a liquid carrier, thereby being a black-colored fusing agent. The black color absorbs most of the emitted energy 125 (i.e., almost nil reflectance) across the full spectrum of visible and UV light (see, e.g., Black series in graph 400). Therefore, a black fusing agent enables the absorption of most of the emitted energy 125 regardless of its wavelengths. Other colored fusing agents may be used if matched with an appropriate emitted energy band of wavelengths so that the colored fusing agents absorbs most of the emitted energy. For example, a yellow fusing agent may absorb about 60% or more of the energy in the band of 380 nm to 500 nm (a blue LED emits energy around 470 nm), a magenta fusing agent may absorb about 60% or more of the energy in the band of 420 nm to 600 nm (a yellow LED emits energy around 590 nm) and a cyan fusing agent may absorb about 60% or more of the energy in the band of 520 nm to 700 nm (a yellow LED emits energy around 590 nm and a red LED emits energy around 640 nm).

The reflective agent 346 is to reflect most of the energy 125 narrow-band of wavelengths emitted by the energy source 120. In some examples, the narrow-band of wavelengths is included in a visible light band of the electromagnetic spectrum corresponding to a color and the reflective agent 346 is of substantially the same color.

A red-colored reflective agent 346 (see, e.g., red series in graph 400) may reflect over 40% of the energy in the band of 640 nm to 770 nm, may reflect over 60% of the energy in the band of 690 nm to 750 nm, may reflect over 80% of the energy in the band of 700 nm to 725 nm, and may have a peak of reflection of about 90% at an energy of 711 nm. Therefore, in an example, a red-colored reflective agent 346 is used in conjunction with an energy source 120 emitting energy 125 at a narrow-band of 695 nm to 750 nm, 700 nm to 725 nm, or any other narrow-band from 640 nm to 770 nm.

A blue-colored reflective agent 346 (see, e.g., blue series in graph 400) may reflect over 40% of the energy in the band of 430 nm to 470 nm, may reflect over 60% of the energy in the band of 440 nm to 465 nm, may reflect over 80% of the energy in the band of 445 nm to 460 nm, and may have a peak of reflection of about 90% at an energy of 455 nm. Therefore, in an example, a blue-colored reflective agent 346 is used in conjunction with an energy source 120 emitting energy 125 at a narrow-band of 440 nm to 465 nm, 445 nm to 460 nm, or any other narrow-band from 430 nm to 470 nm.

In other examples, the narrow-band of wavelengths is included in a UV light band of the electromagnetic spectrum (see, e.g., light violet series in graph 400) and the reflective agent 346 is a UV reflective agent. A UV reflective agent 346 may reflect over 40% of the energy in the band of 405 nm to 435 nm, may reflect over 60% of the energy in the band of 410 nm to 425 nm, may reflect over 80% of the energy in the band of 410 nm to 415 nm, and may have a peak of reflection of 90% at an energy of 412 nm. Therefore, in an example, a UV reflective agent 346 is used in conjunction with an energy source 120 emitting energy 125 at a narrow-band of 410 nm to 425 nm, 410 nm to 415 nm, or any other narrow-band from 405 nm to 435 nm.

Additionally, in some examples, the reflective agent 346 may be a thermochromic composition. A thermochromic composition is a composition that changes its color hue upon a change of temperature. In an example, the reflective agent 346 is a thermochromic colored reflective agent (e.g., blue, red) that changes to a white composition after being exposed to a certain amount of energy 125. In another example, the reflective agent 346 may be a thermochromic colored reflective agent that changes to a colorless composition (e.g., transparent) after being exposed to a certain amount of energy 125. By using the above-mentioned thermochromic compositions as reflective agents 346, the resulting 3D generated object may not have any color trace of the colored reflective agent 346, thereby being in accordance to the aesthetic requirements of the 3D printed part to be generated.

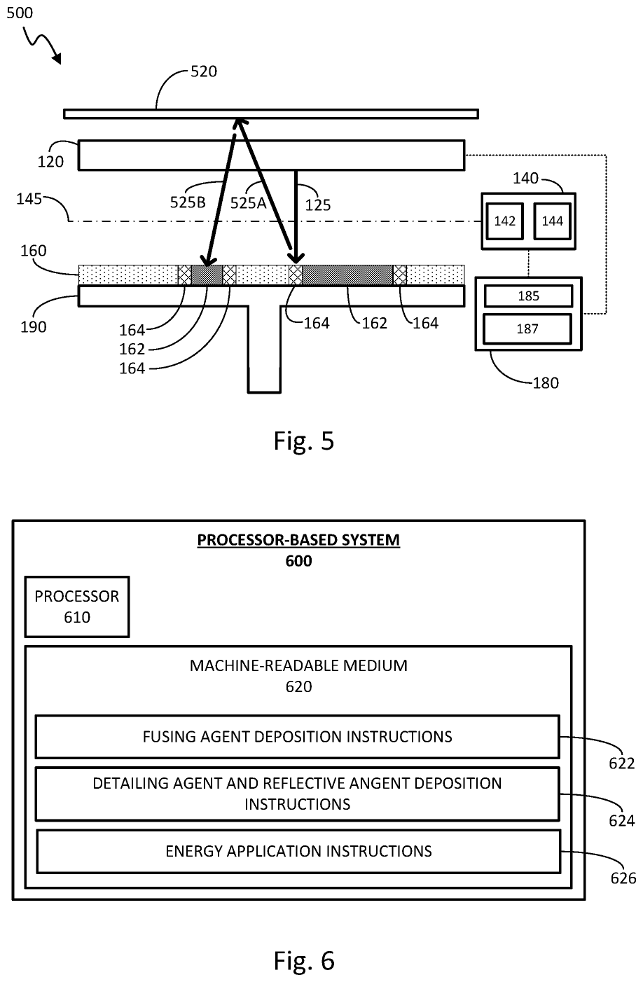

FIG. 5 is another schematic diagram showing an example of a 3D printer 500 with a reflecting element 520. The 3D printer 500 may involve previously disclosed elements from FIG. 1 referred to with the same reference numerals. The 3D printer 500 comprises the energy source 120 to emit energy 125, the agent delivery device 140 with fusing agent 142 and detailing agent 144, and the controller 180. Additionally, the 3D printer 500 may comprise the platform 190 where the build material layer 160 is to be generated thereon. The controller 180 is to control the agent delivery device 140 to selectively deposit fusing agent 142 and detailing agent 144 on the build material layer 160 in the first pattern 162 and second pattern 164 respectively.

The 3D printer 500 further comprises a reflecting element 520, such as a mirror, over the build material layer 160. The energy source 120 is to emit energy 125 towards the first and second patterns 162-164, the energy 125 reached by the first pattern 162 including the fusing agent 142 is absorbed by the fusing agent 142; and the energy 125 reached by the second pattern 164 (illustrated example) including the detailing agent 144 and the reflective agent 346 is mostly reflected 525A by the reflective agent 346. The reflected energy 525A reaches the reflecting element 520 where it is reflected back 525B towards the build material layer 160, where it may be absorbed again by a fusing agent 142 of the first pattern 162. The 3D printer 500 comprising the reflecting element 520 may be more energy efficient since the reflected energy 525A is re-used and thereby not wasted.

FIG. 6 is a block-diagram of a processor-based system 600 example for selectively solidifying portions of a layer of build material in a 3D printer. The processor-based system 600 that includes a machine-readable medium 620 encoded with example instructions to selectively solidifying portions of a layer of build material. In some implementations, the system 600 is a processor-based system and may include a processor 610 coupled to a machine-readable medium 620. The processor 610 may include a single-core processor, a multi-core processor, an application-specific integrated circuit (ASIC), a field programmable gate array (FPGA), and/or any other hardware device suitable for retrieval and/or execution of instructions from the machine-readable medium 620 (e.g., instructions 622-626) to perform functions related to various examples. Additionally, or alternatively, the processor 610 may include electronic circuitry for performing the functionality described herein, including the functionality of instructions 622-626. With respect of the executable instructions represented as boxes in FIG. 6, it should be understood that part or all of the executable instructions and/or electronic circuits included within one box may, in alternative implementations, be included in a different box shown in the figures or in a different box not shown.

The machine-readable medium 620 may be any medium suitable for storing executable instructions, such as a random-access memory (RAM), electrically erasable programmable read-only memory (EEPROM), flash memory, hard disk drives, optical disks, and the like. In some example implementations, the machine-readable medium 620 may be a tangible, non-transitory medium, where the term “non-transitory” does not encompass transitory propagating signals. The machine-readable medium 620 may be disposed within the processor-based system 600, as shown in FIG. 6, in which case the executable instructions may be deemed “installed” on the system 600. Alternatively, the machine-readable medium 620 may be a portable (e.g., external) storage medium, for example, that allows system 600 to remotely execute the instructions or download the instructions from the storage medium. In this case, the executable instructions may be part of an “installation package”. As described further herein below, the machine-readable medium may be encoded with a set of executable instructions 622-626

Instructions 622, when executed by the processor 610, may cause the processor 610 to selectively deposit a fusing agent 142 to a build material layer 160 in a first pattern 162 corresponding to a 3D object to be generated.

Instructions 624, when executed by the processor 610, may cause the processor 610 to selectively deposit a detailing agent 144 and a reflective agent 346 to the build material layer 160 in a second pattern 164 surrounding the first pattern 162, wherein the reflective agent 346 is selected to reflect substantially all of the emitted energy 125 at the wavelengths within the narrow-band of wavelengths.

Instructions 626, when executed by the processor 610, may cause the processor 610 to apply energy 125, via an array of solid-state emitters, to the first pattern 162 and second pattern 164 in a narrow-band of wavelengths to be absorbed by the fusing agent 142.

The above examples may be implemented by hardware, or software in combination with hardware. For example, the various methods, processes and functional modules described herein may be implemented by a physical processor (the term processor is to be implemented broadly to include CPU, SoC, processing module, ASIC, logic module, or programmable gate array, etc.). The processes, methods and functional modules may all be performed by a single processor or split between several processors; reference in this disclosure or the claims to a “processor” should thus be interpreted to mean “at least one processor”. The processes, method and functional modules are implemented as machine-readable instructions executable by at least one processor, hardware logic circuitry of the at least one processor, or a combination thereof.

The drawings in the examples of the present disclosure are some examples. It should be noted that some units and functions of the procedure may be combined into one unit or further divided into multiple sub-units. What has been described and illustrated herein is an example of the disclosure along with some of its variations. The terms, descriptions and figures used herein are set forth by way of illustration. Many variations are possible within the scope of the disclosure, which is intended to be defined by the following claims and their equivalents.

There have been described example implementations with the following sets of features:

Feature set 1: A 3D printing comprising:
an energy source comprising solid-state emitters to selectively emit energy to a build material layer in a narrow-band of wavelengths;
an agent delivery device to selectively deposit a fusing agent and a detailing agent on the build material layer in respective independent patterns;
a controller to:
   control the agent delivery device to selectively deposit the fusing agent to a build material layer in a first pattern corresponding to a 3D object to be generated;
   control the agent delivery device to selectively deposit the detailing agent to the build material layer in a second pattern;
   control the energy source to apply energy to the first pattern and second pattern in the narrow-band of wavelengths, wherein
   the agent delivery device is to selectively deposit a reflective agent in a third pattern, wherein the reflective agent is to reflect substantially all of the energy at the wavelengths within the narrow-band of wavelengths; and
   the controller is to control the agent delivery device to selectively deposit the reflective agent in the third pattern.

Feature set 2: A 3D printer with feature set 1, wherein the solid-state emitters are selected from the group comprising Light Emitting Diodes (LED), Edge Laser Diodes, and Vertical-Cavity Surface-Emitting Lasers (VCSEL).

Feature set 3: A 3D printer with any preceding feature set 1 to 2, wherein the reflective agent is a component of the detailing agent and the second pattern and the third pattern are the same.

Feature set 4: A 3D printer with any preceding feature set 1 to 3, wherein the detailing agent and the reflective agent are separate agents, the controller to control the agent delivery device to separately deposit the detailing agent and the reflective agent on the build material layer in second and third patterns.

Feature set 5: A 3D printer with any preceding feature set 1 to 4, further comprising a reflecting element disposed over the build material layer to reflect energy back to the build material layer.

Feature set 6: A 3D printer with any preceding feature set 1 to 5, wherein the narrow-band of wavelengths corresponds to a color from the visible electromagnetic spectrum and the reflective agent is of substantially the same color.

Feature set 7: A 3D printer with any preceding feature set 1 to 6, wherein the energy source is to emit energy in a part of the band of 430 to 470 nm and the reflective agent is a blue agent.

Feature set 8: A 3D printer with any preceding feature set 1 to 7, wherein the energy source is to emit energy in a part of the band of 405 to 435 nm and the reflective agent is a UV reflective agent.

Feature set 9: A 3D printer with any preceding feature set 1 to 8, wherein the reflective agent is a thermochromic composition.

Feature set 10: A 3D printer with any preceding feature set 1 to 9, wherein the thermochromic composition changes to a white color composition or a colorless composition after being exposed to a predetermined amount of energy.

Feature set 11: A method comprising
selectively depositing, by an agent delivery device, a fusing agent to a build material layer in a first pattern corresponding to a 3D object to be generated;
selectively depositing, by the agent delivery device, a detailing agent to the build material layer in a second pattern;
selectively depositing, by the agent delivery device, a reflective agent to a third pattern, wherein the reflective agent is to reflect substantially all of the energy at the wavelengths within a narrow-band of wavelengths; and
applying energy, via an energy source comprising solid-state emitters, to the first pattern and second pattern in the narrow-band of wavelengths.

Feature set 12: A method with preceding feature set 11, wherein the solid-state emitters are selected from the group comprising Light Emitting Diodes (LED), Edge Laser Diodes, and Vertical-Cavity Surface-Emitting Lasers (VCSEL).

Feature set 13: A method with any preceding feature set 11 to 12, wherein the reflective agent is a component of the detailing agent and the second pattern and the third pattern are the same.

Feature set 14: A method with any preceding feature set 11 to 13, wherein the detailing agent and the reflective agent are separate agents, the method comprising depositing separately the detailing agent and the reflective agent on the build material layer in second and third patterns.

Feature set 15: A non-transitory machine-readable medium storing instructions executable by a processor, the non-transitory machine-readable medium comprising:
instructions to selectively deposit a fusing agent to a build material layer in a first pattern corresponding to a 3D object to be generated;
instructions to selectively deposit a detailing agent to the build material layer in a second pattern;
instructions to selectively deposit a reflective agent to a third pattern, wherein the reflective agent is selected to reflect substantially all of the energy at the wavelengths within a narrow-band of wavelengths; and
instructions to apply energy, via an energy source comprising solid-state emitters, to the first pattern and second pattern in the narrow-band of wavelengths.

What is claimed:

1. A 3D printer comprising:
an energy source comprising solid-state emitters to selectively emit energy to a build material layer in a narrow-band of wavelengths;
an agent delivery device to selectively deposit a fusing agent and a detailing agent on the build material layer in respective independent patterns;
a controller to:
control the agent delivery device to selectively deposit the fusing agent to a build material layer in a first pattern corresponding to a 3D object to be generated;
control the agent delivery device to selectively deposit the detailing agent to the build material layer in a second pattern;
control the energy source to apply energy to the first pattern and second pattern in the narrow-band of wavelengths, wherein
the agent delivery device is to selectively deposit a reflective agent in a third pattern, wherein the reflective agent is to reflect substantially all of the energy at the wavelengths within the narrow-band of wavelengths; and
the controller is to control the agent delivery device to selectively deposit the reflective agent in the third pattern.

2. The 3D printer of claim 1, wherein the solid-state emitters are selected from the group comprising Light Emitting Diodes (LED), Edge Laser Diodes, and Vertical-Cavity Surface-Emitting Lasers (VCSEL).

3. The 3D printer of claim 1, wherein the reflective agent is a component of the detailing agent and the second pattern and the third pattern are the same.

4. The 3D printer of claim 1, wherein the detailing agent and the reflective agent are separate agents, the controller to control the agent delivery device to separately deposit the detailing agent and the reflective agent on the build material layer in second and third patterns.

5. The 3D printer of claim 1, further comprising a reflecting element disposed over the build material layer to reflect energy back to the build material layer.

6. The 3D printer of claim 1, wherein the narrow-band of wavelengths corresponds to a color from the visible electromagnetic spectrum and the reflective agent is of substantially the same color.

7. The 3D printer of claim 6, wherein the energy source is to emit energy in a part of the band of 430 to 470 nm and the reflective agent is a blue agent.

8. The 3D printer of claim 1, wherein the energy source is to emit energy in a part of the band of 405 to 435 nm and the reflective agent is a UV reflective agent.

9. The 3D printer of claim 1, wherein the reflective agent is a thermochromic composition.

10. The 3D printer of claim 9, wherein the thermochromic composition changes to a white color composition or a colorless composition after being exposed to a predetermined amount of energy.

11. A method comprising:
selectively depositing, by an agent delivery device, a fusing agent to a build material layer in a first pattern corresponding to a 3D object to be generated;
selectively depositing, by the agent delivery device, a detailing agent to the build material layer in a second pattern;
selectively depositing, by the agent delivery device, a reflective agent to a third pattern, wherein the reflective agent is to reflect substantially all of the energy at the wavelengths within a narrow-band of wavelengths; and
applying energy, via an energy source comprising solid-state emitters, to the first pattern and second pattern in the narrow-band of wavelengths.

12. The method of claim 11, wherein the solid-state emitters are selected from the group comprising Light Emitting Diodes (LED), Edge Laser Diodes, and Vertical-Cavity Surface-Emitting Lasers (VCSEL).

13. The method of claim 11, wherein the reflective agent is a component of the detailing agent and the second pattern and the third pattern are the same.

14. The method of claim 11, wherein the detailing agent and the reflective agent are separate agents, the method comprising depositing separately the detailing agent and the reflective agent on the build material layer in second and third patterns.

15. A non-transitory machine-readable medium storing instructions executable by a processor, the non-transitory machine-readable medium comprising:
instructions to selectively deposit a fusing agent to a build material layer in a first pattern corresponding to a 3D object to be generated;
instructions to selectively deposit a detailing agent to the build material layer in a second pattern;
instructions to selectively deposit a reflective agent to a third pattern, wherein the reflective agent is selected to reflect substantially all of the energy at the wavelengths within a narrow-band of wavelengths; and
instructions to apply energy, via an energy source comprising solid-state emitters, to the first pattern and second pattern in the narrow-band of wavelengths.
